(19) United States
(12) Patent Application Publication
(10) Pub. No.: US 2009/0132426 A1
(43) Pub. Date: May 21, 2009

(54) Arrangement for Reducing Risk in the Sale of Property

(76) Inventors: Michael John Baron Smith, New South Wales (AU); Michael John Kelly, New South Wales (AU)

Correspondence Address: LADAS & PARRY LLP, 26 WEST 61ST STREET, NEW YORK, NY, 10023, US

(21) Appl. No.: 11/885,701

(22) PCT Filed: Mar. 23, 2006
(86) PCT No.: PCT/AU06/00387

§ 371 Date: Jun. 26, 2008

(30) Foreign Application Priority Data
Mar. 23, 2005 (AU) 2005901466

(51) Int. Cl. G06Q 40/00; G06Q 50/00; G06Q 10/00; G06Q 30/00

(52) U.S. Cl. 705/80; 705/35; 705/38

(57) ABSTRACT

Disclosed are arrangements for selling property off the plan, involving issuing (in a step ‘8’ in FIG. 6) an undertaking from a bank of a purchaser in favour of the developer from whom the property is to be purchased. The undertaking may be assigned (in a step ‘12’ in FIG. 6) to the developer's bank. The undertaking is legally enforceable by the assignee (in a step ‘15′’ in FIG. 6) if the purchaser, notwithstanding the fact that the developer has completely fulfilled the contractual obligations, defaults on his obligation at settlement.

### COPYRIGHT NOTICE

This patent specification contains material that is subject to copyright protection. The copyright owner has no objection to the reproduction of this patent specification or related materials from associated patent office files for the purposes of review, but otherwise reserves all copyright whatsoever.

### FIELD OF THE INVENTION

The present invention relates generally to retail and commercial transactions and, in particular to transactions, taking place at the off-the-plan stage, prior to completion of new property. These transactions are referred to in this specification as “property transactions”.

### BACKGROUND

Property transactions relating to construction and sale of new buildings are, in general, subject to various types of risk. The term “construction risk” relates to the risk that unforeseen difficulties may arise in relation to construction of the new building. Such risks include, for example, bankruptcy of the developer which would halt construction. The term “sales risk” relates, for example, to the risk that the developer, particularly in regard to construction of multi-apartment building complexes, may have difficulty in selling all the apartments. This may, for example, occur because of a downturn in the general economy. The term “settlement risk” relates to the fact that the purchaser of an apartment in a building complex may refuse, or be unable, to pay the outstanding money owed on the apartment when the property transaction reaches the “settlement” date, this being the point at which ownership and possession of the apartment typically pass from the developer to the purchaser, in exchange for which the balance of money owed passes from the purchaser to the developer. The term “purchasers financial risk” refers to firstly, the risk that the purchaser may not receive the finance he or she requires to pay for the desired property. Secondly, and as a consequence of not receiving this finance, the purchaser loses their 10% deposit and receives nothing in return.

FIG. 1 shows a data-flow and process-flow process 100 for a typical prior art property transaction concerning, in this example, sale of an apartment in a complex of apartments. Four parties are involved in the process 100, these being a developer (see 703 in FIG. 3), the developer's bank (referred to as D. bank—see 704 in FIG. 3), a purchaser (see 701 in FIG. 3), and the purchaser's bank, (referred to as P. bank—see 702 in FIG. 3). The property transaction is in the class of transactions referred to “off-the-plan” since the apartment that the purchaser is considering purchasing has not yet been built.

In a step “1” the developer prepares plans for the new apartment complex. The developer also markets the proposed apartment complex in order to identify prospective purchasers. The success of this marketing is highly dependant on the general state of the property market. In a static or falling market there is likely to be a much smaller number of prospective purchasers than in a rising market. At a following step “2” the developer and the purchaser negotiate a price for the apartment in question. At a following step “2′” the developer provides the purchaser with a draft pre-sale contract for sale of land. This contract is reviewed and amended by the purchaser and the purchaser's solicitor through negotiations involving the developer and the developer's solicitor. Prior art pre-sale contracts for sale of land typically do not conform to any standards, and are thus subject to a considerable amount of change between the step “2′” and a step “5” at which time exchange takes place.

At a subsequent step “3” the purchaser approaches his or her bank (referred to as P. bank) which indicates that the requisite funds will be made available to the purchaser at settlement. In a following step “4” the purchaser 701 obtains a deposit bond from a deposit bond provider (not shown), this being typically for 10% of the total purchase price of the apartment. A subsequent step “5” depicts the process of “exchange”. This step effects a contractual agreement between the developer and the purchaser, by which the developer agrees to sell the apartment in question to the purchaser for the price agreed upon in the step “2” and the purchaser agrees to buy the apartment at the noted price. From a practical standpoint, the two parties sign the reviewed and amended pre-sale contract for sale of land, that was negotiated in the step “2′”. In a following step “6” the purchaser hands the aforementioned deposit bond to the developer.

A developer wishing to build a complex of apartments, or any other type of property for that matter, in order to obtain building finance from his or her bank (referred to as D. Bank), typically needs to pre-sell a certain number of apartments off-the plan. This is required in order to provide the developer's bank with sufficient confidence to lend the necessary construction funds to the developer. A subsequent step “7” depicts provision of the pre-sale contracts to the developer's bank. It is noted that a pre-sale contract of this type guarantees, in the event of default by the purchaser, at most the 10% deposit provided by the purchaser at the step “6” and a right to sue for damages.

In a subsequent step “8” the developer's bank lends the construction funds to the developer necessary for the complex. The developer completes construction of the apartment complex in a following step “9”. Thereafter, the purchaser applies for and receives loan approval in a step “10” from the purchaser's bank 702. This loan corresponds to the loan indicated as being available in the step “3”. Notwithstanding Step 3, there is a risk that the purchaser may not be able to obtain this loan. If the purchaser is unable to obtain the loan, the transaction will fail with potential financial losses to both the purchaser and the developer. In relation to the steps “3” and “10”, the sequence of steps shown in FIG. 1 represent only one example of how the process 100 can proceed. Many other processes can be used.

Prior to a step “11” which relates to the process of settlement, the developer may fail to complete the apartment within the time specified by the contract (see the step “9”) and the transaction may fail. In this case the purchaser's deposit would be returned however any costs incurred by the purchaser are not able to be recovered.

In a subsequent step “11” the process of “settlement” occurs, in which the final contractual obligations between the developer and the purchaser are fulfilled. These contractual obligations and the associated activities under the settlement process include, as shown in a step “12” under the pre-sale contract for sale of land that was dealt with in the step “2′”, passing of ownership of the purchased apartment from the developer to the purchaser, and receipt of the final outstanding money owed on the building and sale process by the developer from the purchaser. In practice the loan funds pass directly from the purchaser's bank to the developer (or even directly to the developer's bank). Thereafter, in a step “13” the developer repays to the developer's bank the money received on loan in the step “8” plus any additional charges and interest. It is noted that the purchaser may fail to attend the settlement process in contravention of their contractual obligations. In this case the purchaser's deposit would be forfeited and/or the developer may undertake legal action for specific performance of the contract and/or damages.

Clearly the example described in relation to FIG. 1 is only one example of a property transaction. Thus, for example, the process steps may occur in a different sequence to that shown. Furthermore, the purchaser may have sufficient funds of their own, and may not need to approach the purchaser's bank for funds, either for a deposit, or indeed even for settlement.

FIG. 2 shows a prior art process 500 by which the property transaction shown in FIG. 1 is performed. The process 500 starts at a step 501, which as noted in regard to FIG. 1 typically includes marketing activity by the developer, after which in a step 502 the purchaser and developer exchange the pre-sale contract for sale of land as depicted in the step “5” in FIG. 1. Thereafter, in a step 503, the developer completes the project as depicted in the step “9” in FIG. 1. A following testing step 504 determines if there is a deviation between the final apartment produced by the developer and the apartment specified in the contract settled in the step 502 as described in relation to the step “11” in FIG. 1. If there is no such deviation, then the process 500 follows a NO arrow to a step 505 in which the purchaser must fulfil his or her obligations under the contract exchanged in the step 502. The process 500 then is directed to an END step 506.

Returning to the testing step 504, if there is a deviation between the built apartment and the apartment description in the contract, then the process 500 follows a YES arrow to a step 507 which determines whether the aforementioned deviation is “major” or “minor”. If it is determined, under the applicable contract law, that the deviation is a major deviation, then the process 500 follows a YES arrow to a step 508 in which the developer must rectify the deviation, or compensate the purchaser appropriately. The process 500 then is directed to the step 505.

Returning to the step 507, if the deviation is a minor deviation, then the process 500 follows a NO arrow to a step 509. The step 509 typically depicts the situation in which the purchaser may refuse to meet his or her legal obligation to complete the settlement process (as depicted by the step “11” in FIG. 1) by referring to one of the aforementioned minor matters. In many instances, this situation arises because the purchaser is attempting to use the minor matter as a pretext for not settling, because the purchaser has changed their mind. In such a situation the developer can enforce settlement through the courts and resolve the minor issue as part of the court decision. From a practical perspective, however, the developer may wish to avoid the cost and trouble associated with court proceedings. If this is not the case (ie if the developer is willing to take the matter to court), then the process 500 follows a YES arrow to a step 510 in which court proceedings are instituted in order to compel the purchaser to meet his or her contractual obligations, providing that the developer rectifies the minor deviation in the step 511. After the steps 510 and 511 the process 500 is directed back to the step 505.

Returning to the step 509, if the developer concludes that it is not commercially sensible to commence court proceedings, as is often the case, then the process 500 follows a NO arrow to a step 512 in which the developer must “coax” the purchaser into meeting their contractual obligations.

The steps 509-512 depict a relatively minor type of settlement risk faced by the developer in the process 500. Once the step 512 is satisfactorily completed, then the process 500 is directed back to the step 506. A more major type of settlement risk arises when a purchaser is unable to find the fluids to settle the purchase. In this situation the developer gets the 10% deposit provided at the step “6” in FIG. 1, but probably no more due to the costs involved in pursuing the purchaser (who may, for example, be an off-shore buyer). The purchaser loses their 10% deposit and receives nothing in return. This is referred to as the purchaser's “finance risk” (also referred to as the purchaser's financial risk”). In addition, the purchaser loses any other funds which have been expended in relation to the purchase, such as legal fees.

The settlement risk faced by the developer, as exemplified by the steps 509-512 in FIG. 2, typically lead the developer's bank to decrease the Loan-to-Value Ratio (LVR) used by the developer's bank in providing the finance in the step “8” in FIG. 1.

The developer's bank will generally not lend more than a percentage of the estimated value of the total apartment complex to the developer. The Loan to Value Ratio (LVR) reflects this situation. Thus a loan of $8 m in relation to a construction project projected to cost $10 m represents an LVR of 80%. A lower loan of $7 m on the same project represents a (lower) LVR of 70%. A low LVR typically will force the developer to seek (more expensive) additional financing in order to obtain the total amount of finance required in the step “8”. This is clearly a disadvantage for the developer, who must then pass on higher prices to the purchaser, thus making the sale less attractive to prospective purchasers, or alternatively take a smaller profit.

In some situations, purchasers pay for newly constructed property by a series of progress payments throughout the construction period rather than by a single payment upon completion of the property. These situations can apply to both single unit dwellings and to apartments within multi-unit complexes.

Payment of any monies in these situations, before completion and therefore before title is transferred, gives rise to various risks for both the purchaser the builder/developer and their respective banks.

The developer has a “finding risk” whereby the purchaser may not be able to meet the progress payments as and when they fall due leading to a shortfall in construction funding.

The purchaser has a “financial risk” in that the progress payments may not be properly applied to the construction of the property resulting in the purchasers asset being worth considerably less than the amounts that have been paid.

The purchaser also assumes a “construction risk” in that the developer/builder may be unable to complete the property notwithstanding that the purchaser has paid substantial monies to the developer/builder. This would leave the purchaser with an incomplete property that will cost significantly more to complete than originally contracted.

The purchasers bank has risks that are derived from the purchasers risks. The possibility exists that funds advanced to the purchaser to meet progress payments can be diverted, by either the purchaser or the developer/builder, to other purposes.

### SUMMARY

It is an object of the present invention to substantially overcome, or at least ameliorate, one or more disadvantages of existing arrangements.

Disclosed are arrangements, generally referred to as “mbill arrangements”, or alternatively referred to as arrangements operating under the “mbill system”. These arrangements seek to address the above problems by obtaining an undertaking (referred to as an “mbill system undertaking” or merely as an “undertaking”) from a bank or other financial institution or finance provider. In one example the bank is the purchaser's bank.

In another example, the other financial institution is an entity such as an insurance company. However, this is only an example, and it could be issued by a generic “person” being a generalised legal entity encompassing an individual “real” person or a “legal” person such as a company.

In one example, the mbill system undertaking is in favour of the developer. In another example the mbill system undertaking is in favour of a bank or other financial institution for the indirect benefit of the developer. Again the other financial institution could be an entity such as an insurance company and again this is only an example, and it could be in favour of a generic “person” being a generalised legal entity encompassing an individual “real” person or a “legal” person such as a company.

The mbill system undertaking may be assigned to the developer's bank. The mbill system undertaking is legally enforceable by the developer, or the assignee, if the purchaser, notwithstanding the fact that the developer has completely fulfilled, under the contract, the obligations which are critical to settlement, defaults on his obligation at settlement. It is noted that some contractual matters are minor, and while they must be rectified in due course, they are not legitimate reasons for holding up settlement.

As part of the mbill arrangements, the pre-sale contract for sale of land is substantially standardised. This standardised document is referred to as an mbill system pre-sale contract for sale of land, an mbill contract, or merely as a contract. The aforementioned standardisation is effected in the first instance in order to incorporate the specific processes used in mbill arrangements (as will be described, for instance, in regard to FIG. 6). Secondly, the standardisation enables the purchaser's bank to substantially reduce the effort and time used to review and approve the contract in a step 5 in FIG. 6. Furthermore, this standardisation enables the purchaser and the developer to significantly reduce the amount of review, and probably amendment, required in the step “2′” in FIG. 1.

The purchaser is, in one arrangement, provided with a rebate on the listed purchase price of the property as an incentive for conducting the purchase under the mbill arrangements.

Furthermore, the purchaser's bank receives a fee from the purchaser, in one example, for participating in the mbill arrangement. The respective sales risk and settlement risk for the developer and the developer's bank are substantially reduced or even eliminated by operating under the disclosed mbill arrangements.

In another arrangement, where the purchaser provides an mbill system undertaking in lieu of making progress payments to the developer/builder, the rebate may not be required. In this example, the risks of the purchaser and the purchasers bank, of progress payments being diverted away from the construction of the property is substantially removed as a single payment is made to the developer/builder on completion of the property and delivery of title. In this example the developer is able to use the mbill system undertaking to obtain bank finance to fund the construction. The mbill arrangements ensure that the developer will be paid in full for the property upon completion.

The purchaser, in a preferred arrangement, receives a pre-approval for the loan required at settlement, and is therefore guaranteed that the required funds will be available at settlement. In this arrangement, the purchaser's finance risk is substantially reduced, or even eliminated, by operating under the disclosed mbill arrangements. This reduction/removal of the purchaser's finance risk would typically increase the likelihood that the purchaser would commit to an off-the-plan purchase. This acts indirectly as a sales tool for the developer, and effectively increases the effectiveness of the developer's marketing efforts.

The mbill system undertaking is a time-limited, conditional, stand-by banker's undertaking, which is issued by the purchaser's bank. In one arrangement, the undertaking is made in favour of the developer, and is enforceable by the developer if (i) all the conditions defined by the mbill system undertaking are fulfilled, and (ii) the purchaser does not, or cannot complete the settlement process as required. In another example, where the mbill system undertaking is assigned to a financial or other institution (or is issued to a financial or other institution for the benefit of the developer) it is enforceable by that institution.

The mbill system refers, in one arrangement, to logical entities 701-705 (see FIG. 3) communicating as depicted in FIG. 4, in order to provide a service, one example of which is described in relation to FIG. 6.

Preferably, where a developer fails to deliver the property as specified in the contract, the mbill undertaking is returned to the purchaser, the purchaser is thus out of pocket for the fees that have been paid to the bank, however an insurance product is available through a third party which will reimburse the purchasers costs in the event of non-delivery of the product by the purchaser.

According to a first aspect of the present invention, there is provided a system for selling a property off the plan, by a developer to a purchaser, prior to completion of the property, the system comprising:

a contract according to which the developer agrees to complete the property and sell the property to the purchaser for a first amount;

a time-limited, conditional, stand-by undertaking that a finance provider of the purchaser will, subject to completion of the property and receipt of a document needed to obtain title to the property, pay a second amount that is related to the first amount to a finance provider of the developer;

an electronically accessible register;

a machine comprising a memory for storing a program and a processor for executing the program, said program comprising:
code for accessing the electronically accessible register to ensure that a right over the undertaking has not been accepted by another party;

said right over the undertaking, which, if it has not been accepted by a said other party, is provided to a finance provider of the developer; said program further comprising:
code for registering acceptance by the finance provider of the developer of the provided right over the undertaking on the register; and

a payment, if the purchaser does not pay the second amount to the developer upon completion of the property and receipt a document needed to obtain title over the property, by the finance provider of the purchaser of the second amount to the finance provider of the developer provided that (i) the finance provider of the developer cashes in the undertaking; and (ii) the property has been completed and the document needed to obtain title to the property is provided to the finance provider of the purchaser.

According to another aspect of the present invention, there is provided a register, being electronically accessible, in a system for selling a property off the plan, the selling being by a developer to a purchaser, prior to completion of the property, the system comprising (a) a contract according to which the developer agrees to complete the property and sell the property to the purchaser for a first amount; (b) a time-limited, conditional, stand-by undertaking that a finance provider of the purchaser will, subject to completion of the property and receipt of a document needed to obtain title to the property, pay a second amount that is related to the first amount to a finance provider of the developer; and (c) a machine comprising a memory for storing a program and a processor for executing the program; said register comprising:

means for providing, in accordance with coded instructions in said program, access to stored data, said access enabling confirmation in accordance with the data that a right over the undertaking has not been accepted by another party; and

means for enabling, in accordance with coded instructions in said program, registration of acceptance by the finance provider of the developer of a right over the undertaking on the register if said right over the undertaking has not been accepted by another party.

According to another aspect of the present invention, there is provided a method of selling a property off the plan, by a developer to a purchaser, prior to completion of the property, the method comprising the steps of:

effecting a contract according to which the developer agrees to complete the property and sell the property to the purchaser for a first amount;

issuing a time-limited, conditional, stand-by undertaking that a finance provider of the purchaser will, subject to completion of the property and receipt of a document needed to obtain title to the property, pay a second amount that is related to the first amount to a finance provider of the developer;

accessing an electronically accessible register to ensure that a right over the undertaking has not been accepted by another party;

if a said right over the undertaking has not been accepted by a said other party, providing a right over the undertaking to a finance provider of the developer and registering acceptance by the finance provider of the developer of the provided right over the undertaking on the register; and

if the purchaser does not pay the second amount to the developer upon completion of the property and receipt a document needed to obtain title over the property, the finance provider of the purchaser paying the second amount to the finance provider of the developer provided that (i) the finance provider of the developer cashes in the undertaking; and (ii) the property has been completed and the document needed to obtain title to the property is provided to the finance provider of the purchaser.

According to another aspect of the present invention, there is provided a method of selling a property off the plan, by a developer to a purchaser, prior to completion of the property, the method comprising the steps of:

effecting a contract according to which the developer agrees to complete the property and sell the property to the purchaser for a first amount;

issuing a time-limited, conditional, stand-by undertaking that a finance provider of the purchaser will, subject to completion of the property and receipt of a document needed to obtain title to the property, pay a second amount that is related to the first amount to a finance provider of the developer;

providing a right over the undertaking to the finance provider of the developer; and

if the purchaser does not pay the second amount to the finance provider of the developer upon completion of the property, the finance provider of the purchaser paying the second amount to the finance provider of the developer provided that (i) the finance provider of the developer cashes in the undertaking; and (ii) the property has been completed and the document needed to obtain title to the property is provided to the finance provider of the purchaser.

According to another aspect of the present invention, there is provided a method of selling a property off the plan, by a developer to a purchaser, prior to completion of the property, wherein a time-limited, conditional, stand-by undertaking is issued by a finance provider of the purchaser that said finance provider of the purchaser will, subject to completion of the property and receipt of a document needed to obtain title to the property, pay a second amount to a finance provider of the developer; the method comprising the steps of:

effecting a contract according to which the developer agrees to complete the property and sell the property to the purchaser for a first amount that is related to the second amount;

providing a right over the undertaking to the finance provider of the developer; and

if the purchaser does not pay the second amount to the finance provider of the developer upon completion of the property, receiving, from the finance provider of the purchaser, said second amount provided that (i) the finance provider of the developer cashes in the undertaking; and (ii) the property has been completed and the document needed to obtain title to the property is provided to the finance provider of the purchaser.

According to another aspect of the present invention, there is provided a method of purchasing a property off the plan, by a purchaser from a developer, prior to completion of the property, the method comprising the steps of:

effecting a contract according to which the developer agrees to complete the property and sell the property to the purchaser for a first amount;

arranging for issue of a time-limited, conditional, stand-by undertaking that a finance provider of the purchaser will, subject to completion of the property and receipt of a document needed to obtain title to the property, pay a second amount that is related to the first amount to a finance provider of the developer if the undertaking is cashed in: and

ensuring, consequent to the arranging of the undertaking, availability of funds required by the purchaser to complete the purchase from the finance provider of the purchaser.

According to another aspect of the present invention, there is provided a method of providing finance by a finance provider of a developer to the developer, in relation to sale of a plurality of properties off the plan, by the developer to a corresponding plurality of purchasers, prior to completion of the properties, the method comprising the steps of:

receiving rights over a corresponding plurality of time-limited, conditional, stand-by undertakings issued by respective finance providers of the purchasers that each said finance provider of a said purchaser will, subject to completion of the corresponding property and receipt of a document needed to obtain title said property, pay a corresponding second amount to the developer;

increasing the Loan-to-Value ratio associated with the provision of the finance depending upon the receiving of the rights over the undertakings; and

providing said finance according to the increased Loan-to-Value ratio.

According to another aspect of the present invention, there is provided a method of providing finance by a finance provider of a purchaser to the purchaser in relation to purchase of a property off the plan, by the purchaser from a developer, prior to completion of the property, the method comprising the steps of:

effecting a contract according to which the developer agrees to complete the property and sell the property to the purchaser for a first amount; and

arranging for issue of a time-limited, conditional, stand-by undertaking that the finance provider of the purchaser will, subject to completion of the property and receipt of a document needed to obtain title to the property, pay a second amount that is related to the first amount to the finance provider of the developer if the undertaking is cashed in.

According to another aspect of the present invention, there is provided a system upon which the above methods can be performed.

According to another aspect of the present invention, there is provided a computer program product including computer readable media having recorded thereon computer programs for directing processors in the above system to execute the above-noted methods.

According to another aspect of the present invention, there is provided a computer program for directing processors in the above system to execute the above-noted methods.

Other aspects of the invention are also disclosed.

### BRIEF DESCRIPTION OF THE DRAWINGS

Some aspects of the prior art and one or more embodiments of the present invention will now be described with reference to the drawings and appendices, in which:

FIG. 1 shows a data-flow and process-flow for a typical prior art property transaction;

FIG. 2 shows flow chart of a prior art process by which the property transaction shown in FIG. 1 is performed;

FIG. 3 depicts the parties involved in the disclosed mbill arrangements and some of the commercial benefits accruing from the disclosed mbill arrangements;

FIG. 4 shows a functional block diagram of one example of an mbill system for performing the mbill arrangements over a communication network infrastructure;

FIG. 5 is a schematic block diagram of an interconnected computer system upon which described methods for mbill arrangements can be practiced;

FIG. 6 shows data-flow and process-flow for performing the disclosed mbill arrangement;

FIG. 7 shows a flow chart of a process showing how the mbill arrangement of FIG. 6 is used in a property transaction;

FIG. 8 shows a how the mbill arrangement enables the developer's bank to provide funds for future projects prior to completion of a current project;

FIG. 9 shows a flow chart of a process by which the service provider licenses banks and developers on a register;

FIG. 10 depicts a flow chart of a process according to which a purchaser's bank issues an mbill system undertaking;

FIGS. 11A and 11B show flow charts of process fragments which incorporate register operations into the process in FIG. 6; and

FIG. 12 shows how the purchaser's bank determines whether to honour the mbill system undertaking in FIG. 11A.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

This description is directed, as an illustrative example, to a property transaction in which a purchaser wishes to buy an apartment in an apartment complex being built by a developer. This is, however, only one example of how the disclosed mbill arrangement can be used.

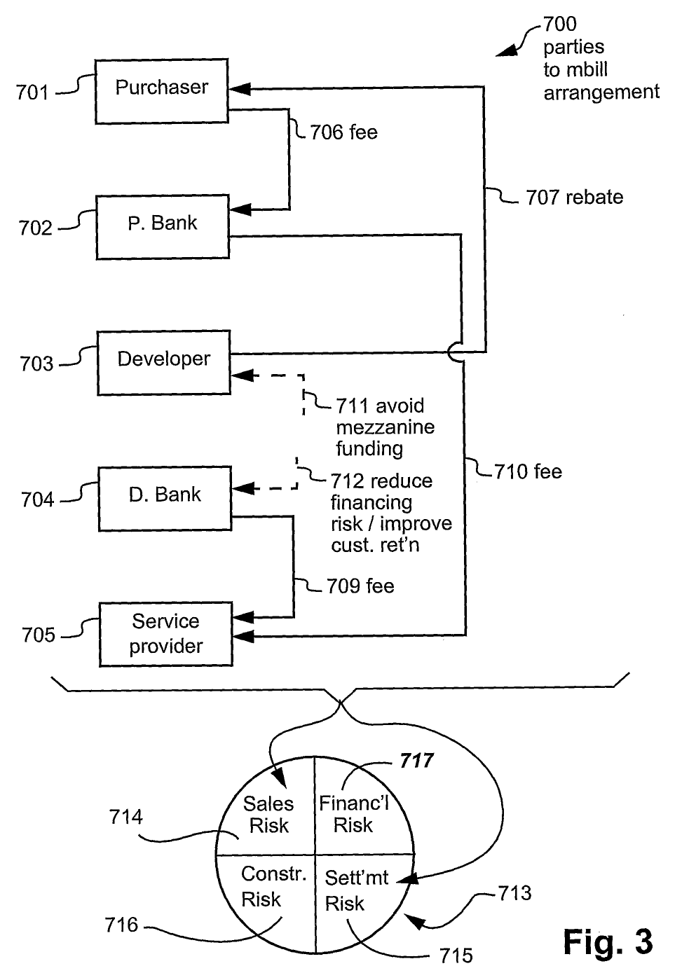

FIG. 3 depicts the various parties involved in the disclosed mbill arrangements, and shows some of the typical commercial benefits flowing to each party under the disclosed arrangements. The parties involved are a purchaser 701, the purchaser's bank 702, a developer 703, the developer's bank 704, and a service provider 705. Clearly the purchaser 701 can select between a multitude of purchaser's banks, and the developer can choose one of a large number of developer's banks, however only one purchaser's bank and one developer's bank are shown for illustration. Furthermore, there could be more than one service provider 705, operating under a franchise arrangement for example.

It is noted that property transactions are dynamic and, for example, the purchaser 701 may, under some circumstances, change relationships with their bank in mid-transaction. Similarly, a developer may merge with a competitor to form a merged legal entity during construction of an apartment complex. The presence of so many potential participants and other variables in a dynamic property transaction environment requires that accurate up-to-date information on the current status of property transactions being transacted under the mbill arrangements be available to all parties at any time. In order to provide this data access capability, the service provider 705 maintains a register containing property transaction data.

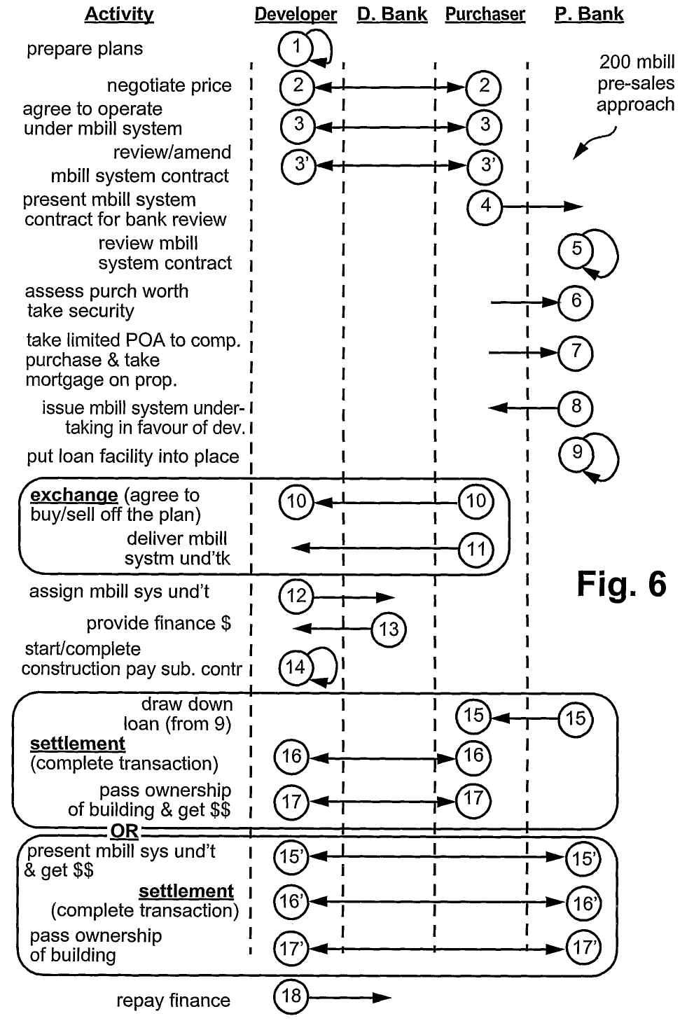

The purchaser 701 pays a fee 706 to the purchaser's bank 702 (also referred to as the finance provider of the purchaser) in relation to the service provided by the purchaser's bank operating under the mbill system. These services relate to issuing an mbill system undertaking as shown, for example, in a step “8” in FIG. 6, and, if necessary, paying out on an mbill system undertaking that is presented (ie cashed in) in a step “15′” in FIG. 6. The fee 706 typically ranges between 1.5% p.a. to 2.5% p.a. of the face value of the mbill system undertaking. This fee 706 includes the fee 710 that is paid by the purchaser bank to the service provider. Although typically the purchaser's bank will obtain a valuation on a property to be purchased under the mbill arrangements, the “face value” of the mbill system undertaking is dependent on the price that is agreed/negotiated in a step “2” in FIG. 6.

As noted above, valuations will be obtained by the purchaser's bank on a property to be purchased under the mbill arrangements. However a rebate 707 received by the purchaser 701 is dependent upon the price that is agreed/negotiated in the step “2” in FIG. 6. This rebate is significant, and typically ranges from 1.5% to 5% of the valued apartment for a typical situation in which settlement is 12 to 18 months away from the time the mbill system undertaking is issued. The level of the aforementioned rebate is consistent with the case in which the purchaser is not gaining any additional benefit (or discount) other than that of having their finance guaranteed. Other rebate levels can apply depending upon the specific circumstances. These circumstances could include the situation where an mbill system undertaking is provided in lieu of making progress payments, in which case the rebate may be 0%. The rebate provides an incentive to the purchaser 701 to operate under the mbill arrangement. The rebate is not intended to vary with any subsequent independent valuation. However, the size of the rebate can, in some arrangements, vary with the time to settlement. Thus in the less likely situation where a very short time remains to settlement, the rebate could be less than 1.5%. Another variable that can be considered when setting the rebate level is the size and profile of the developer and builder concerned.

The purchaser's bank 702 pays a fee 710 to the service provider for being able to operate under the mbill arrangements. This 710 fee comprises two components, one component being a nominal license fee, which allows the bank to participate in the mbill system, and the second component being a per-transaction fee relating to the specific property transaction in question, which is the main fee. This per-transaction fee is based on the face value of the mbill system undertaking.

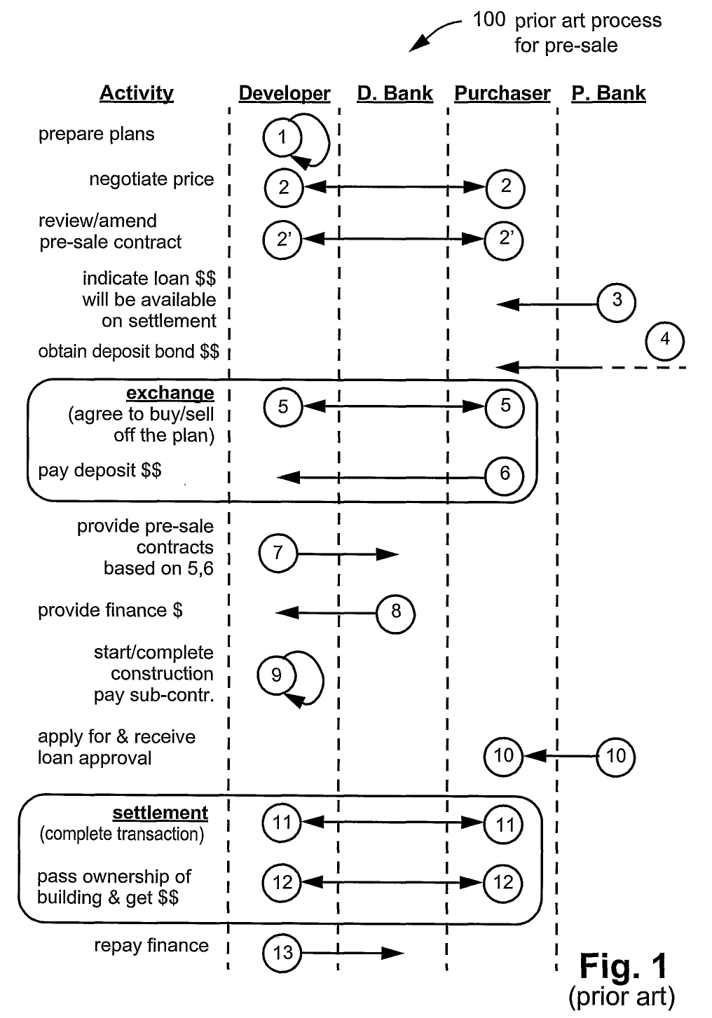

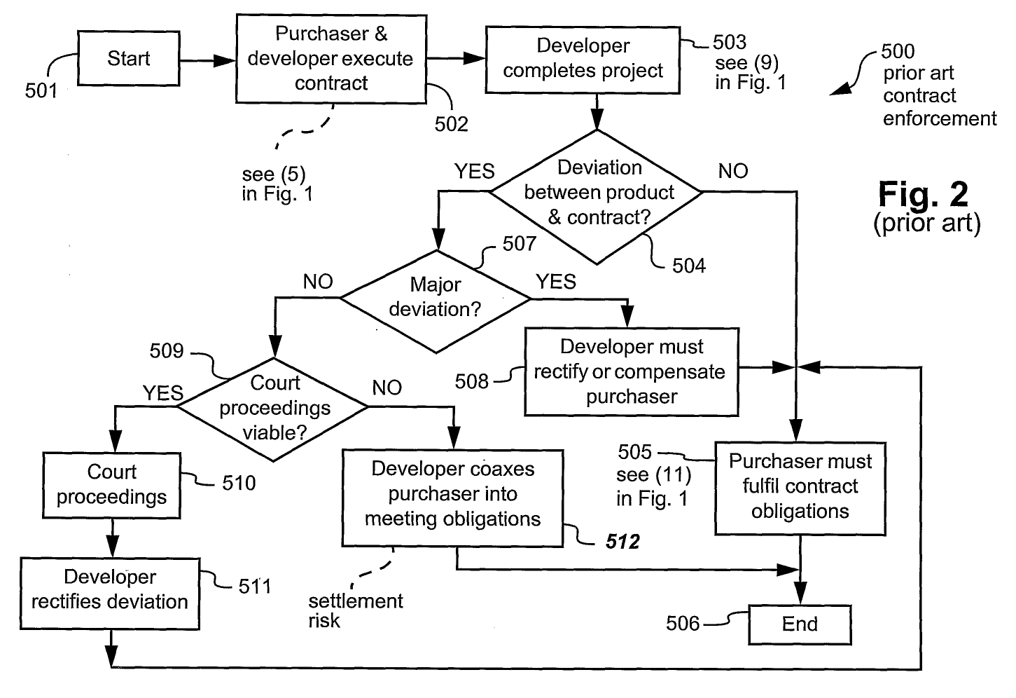

If the LVR defined by the developer's bank (also referred to as the finance provider of the developer) is too low, then the developer's bank may not be prepared to provide sufficient finance (eg see the step “8” in FIG. 1) to satisfy the developer's requirements. Under the mbill arrangement the developer's bank 704 is, as depicted by a dashed arrow 712, under reduced financing risk and can establish a higher LVR thus increasing the amount of funds that can be loaned to the developer. The developer's bank also achieves improved customer retention by virtue of providing higher LVR finance to developers, as depicted by the dashed arrow 712.

By operating under the disclosed mbill arrangements, the developer 703 is thus able to avoid or reduce, as depicted by a dashed arrow 711, the need to obtain:
(a) expensive financing (often referred to as “mezzanine” financing) in order to top-up the finance received at the step “8” in FIG. 1 from the developer's bank, or
(b) expensive forms of credit enhancement (often referred to as “renounceable sales contracts” or “put options”).

This is due to the fact that the developer's bank can use a higher LVR and can lend more money to the developer.

The developer's bank pays a nominal license fee 709 to the service provider 705 in order to operate under the disclosed mbill arrangement.

As depicted at 713 at the bottom of FIG. 3 the disclosed mbill arrangements substantially reduce, or even eliminate sales risk 714 and settlement risk 715 to the extent that mbill system undertakings are obtained in regard to the construction project in question. In addition, the disclosed mbill arrangements mitigate construction risk 716 to the extent that they allow construction projects to commence earlier, thereby reducing holding costs and exposure to future changes in economic circumstances.

Furthermore, the disclosed mbill arrangements substantially reduce, or even eliminate finance risk 717 to the extent that the loan required by the purchaser at settlement is pre-approved when the mbill system undertaking is issued and the purchaser will not lose their 10% deposit.

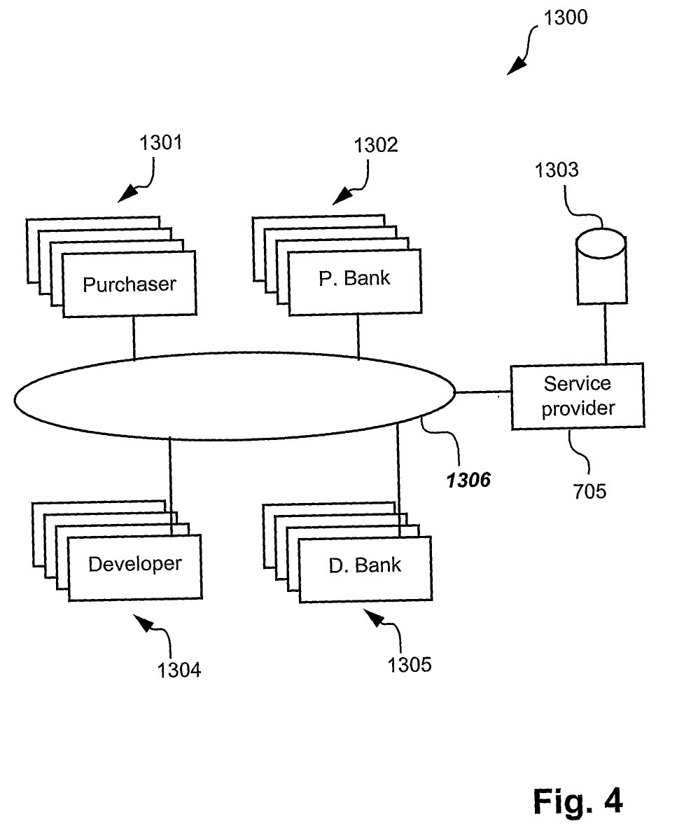

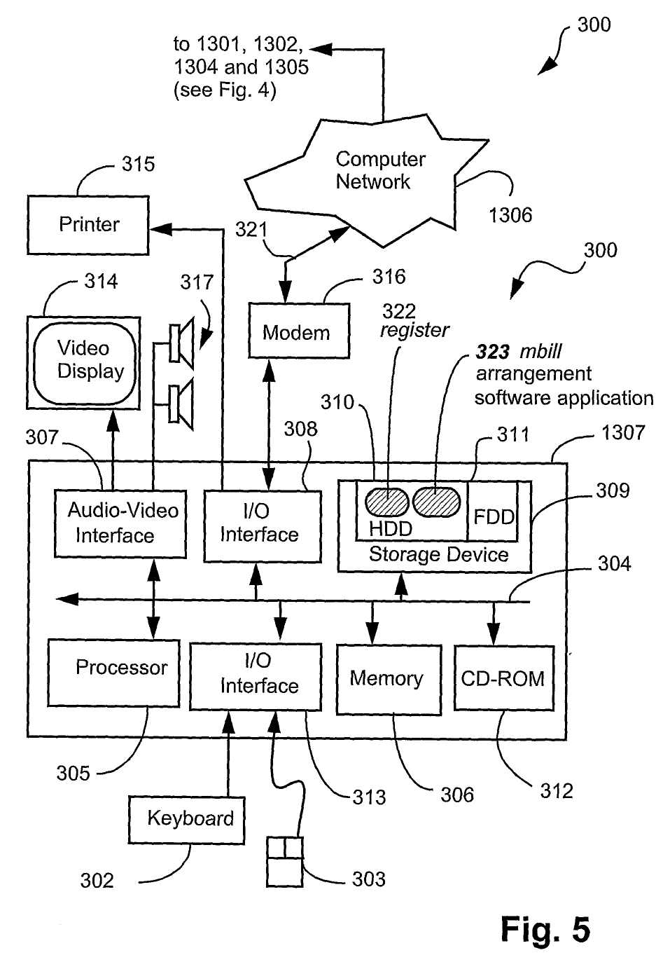

FIG. 4 shows a system 1300 for performing the mbill arrangements over a communication network infrastructure. This type of arrangement is advantageous in order to provide the real time synchronization of information on a register 322 (see FIG. 5) maintained on a database 1303, which consequently provides certainty of information to all system participants. A group of purchasers 1301 are able to communicate, using computer technology, over a communications network 1306 with a corresponding plurality of purchaser's banks 1302. A group of developers 1304 is similarly able to communicate over the network 1306 with their corresponding developer's banks 1305. All the aforementioned parties are able to communicate over the network 1306 with the service provider 705 (also see FIG. 3) which, among other activities, maintains the registry 322 on the database 1303.

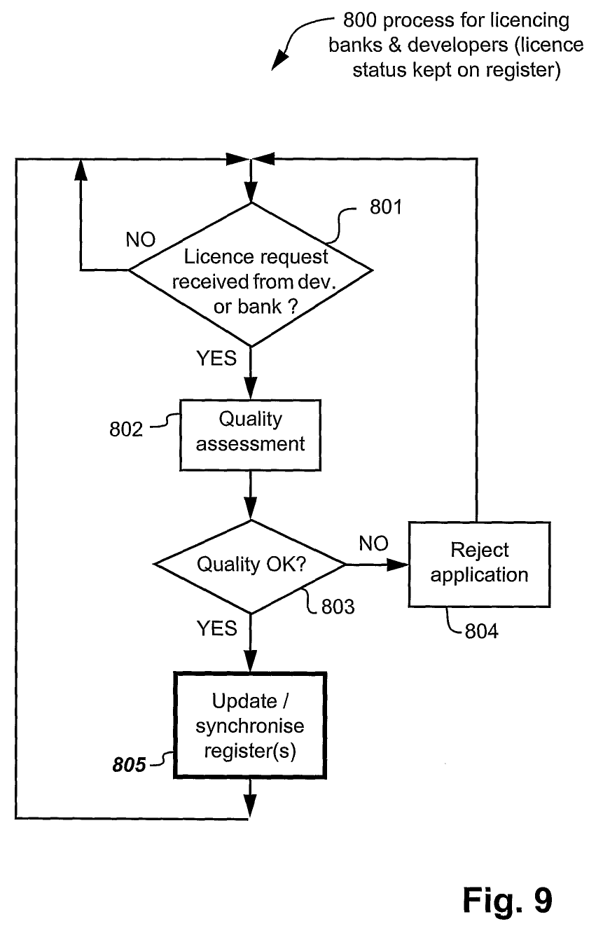

All participating banks (ie., 1302 and 1305) and all participating developers (ie., 1304) are “licensed” by the service provider 705 on the register 322 maintained on the database 1303. The licensing of developers is typically at the instigation of the developer's bank. Building projects (such as building the apartment complex from which the purchaser 701 wishes to buy an apartment) are also registered on the register, and dealings (such as assignments) with mbill system undertakings are also registered. As will be described in relation to FIGS. 9-12, some of the individual steps in the process 200 of FIG. 6 are registered on the register 322 and these register entries are used for verification and authentication purposes throughout the various mbill arrangement process steps. This ensures that in the dynamic environment in which the property transactions take place, the secure and synchronised register enables access to required information by all parties with the requisite amount of confidence, confidentiality and security.

FIG. 5 is a schematic block diagram of an interconnected computer system upon which described methods for mbill arrangements can be practiced. The implementation of mbill arrangements particularly lends itself to implementation on a system 300 of interconnected computers, such as that shown in FIG. 5 wherein the processes of FIGS. 6-12, may be implemented as software, such as one or more application programs executing within the computer system 300. In particular, the steps of method for mbill arrangement are affected by instructions in the software that are carried out by the computer(s). The instructions may be formed as one or more code modules, each for performing one or more particular tasks. The software modules may also be divided into two separate parts, in which a first part performs the mbill arrangement methods, and a second part manages a user interface between the first part and the user. The software may be stored in a computer readable medium, including the storage devices described below, for example. The software is loaded into the computers in FIG. 4 from the computer readable medium, and then executed by the computer. A computer readable medium having such software or computer program recorded on it is a computer program product. The use of the computer program product in the computer preferably effects an advantageous apparatus for effecting mbill arrangements.

The computer system 300 is formed by a computer module 1307 associated with the service provider 705 (see FIG. 3), input devices such as a keyboard 302 and mouse 303, output devices including a printer 315, a display device 314 and loudspeakers 317. A Modulator-Demodulator (Modem) transceiver device 316 is used by the computer module 1307 for communicating to and from the communications network 1306 (see FIG. 4), for example connectable via a telephone line 321 or other functional medium. The modem 316 can be used to obtain access by the service provider to the purchasers 1301, the purchaser's banks 1302, the developers 1304 and the developer's banks 1305, over the network 1306 which can comprise the Internet, and other network systems, such as a Local Area Network (LAN) or a Wide Area Network (WAN). The modem 316 may be incorporated into the computer module 1307 in some implementations.

The computer module 1307 typically includes at least one processor unit 305, and a memory unit 306, for example formed from semiconductor random access memory (RAM) and read only memory (ROM). The module 1307 also includes an number of input/output (I/O) interfaces including an audio-video interface 307 that couples to the video display 314 and loudspeakers 317, an I/O interface 313 for the keyboard 302 and mouse 303, and an interface 308 for the modem 316 and printer 315. In some implementations, the modem 316 may be incorporated within the computer module 1307, for example within the interface 308. A storage device 309 is provided and typically includes a hard disk drive 310 and a floppy disk drive 311. A magnetic tape drive (not illustrated) may also be used. A CD-ROM drive 312 is typically provided as a non-volatile source of data. The components 305 to 313 of the computer module 1307, typically communicate via an interconnected bus 304 and in a manner which results in a conventional mode of operation of the computer system 300 known to those in the relevant art. Examples of computers on which the described arrangements can be practised include IBM-PC's and compatibles, Sun Sparcstations or computer systems evolved therefrom.

Typically, an mbill arrangement application program 323 is resident on the hard disk drive 310 (and on those of the computers used by the other participants in the mbill system being used) and is read and controlled in its execution by the processor 305 or by the respective processors in the computers being considered. A register 322 is also resident on the hard disk drive 310 and is accessed by the processor 305. Intermediate storage of the program and any data fetched from the network 1306 may be accomplished using the semiconductor memory 306, possibly in concert with the hard disk drive 310. In some instances, the application program may be supplied to the user encoded on a CD-ROM or floppy disk and read via the corresponding drive 312 or 311, or alternatively may be read by the user from the network 1306 via the modem device 316. Still further, the software can also be loaded into the computer system 300 from other computer readable media. The term “computer readable medium” as used herein refers to any storage or transmission medium that participates in providing instructions and/or data to the computer system 300 for execution and/or processing. Examples of storage media include floppy disks, magnetic tape, CD-ROM, DVD-ROM, a hard disk drive, a ROM or integrated circuit, a magneto-optical disk, or a computer readable card such as a PCMCIA card and the like, whether or not such devices are internal or external of the computer module 1307. Examples of transmission media include radio or infra-red transmission channels as well as a network connection to another computer or networked device, and the Internet or Intranets including e-mail transmissions and information recorded on Websites and the like.

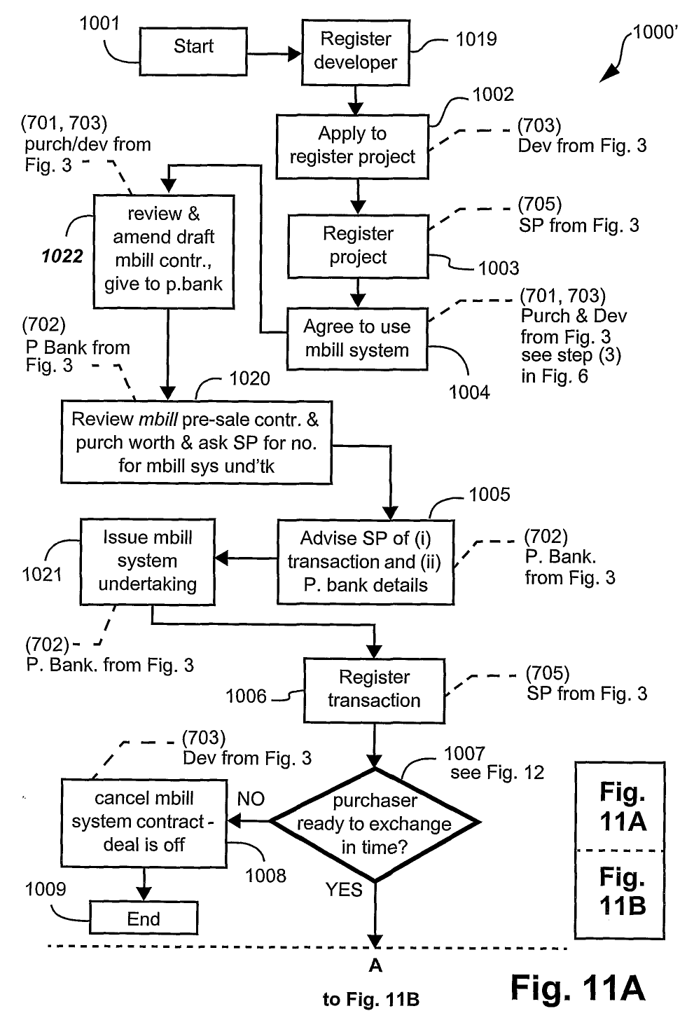

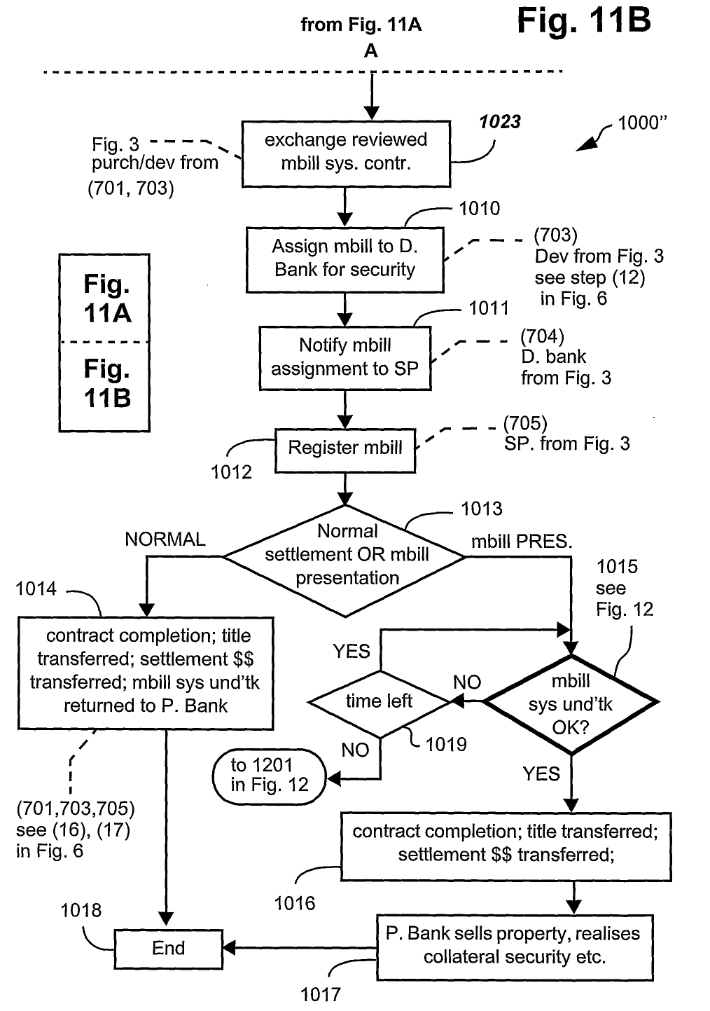

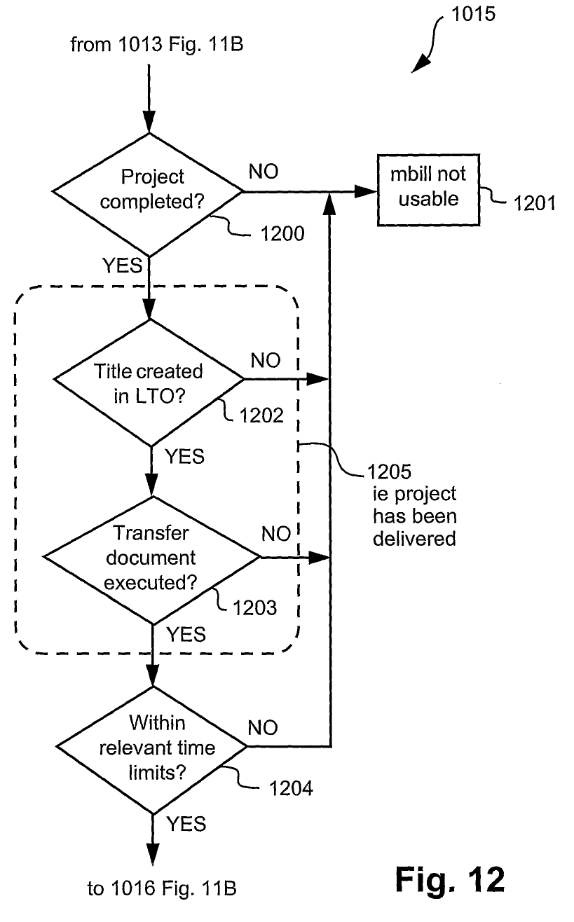

FIG. 6 shows a data-flow and process-flow for performing an example of the disclosed mbill arrangement. The participants in the disclosed mbill arrangement include the developer 703, the developer's bank 704, the purchaser 701, and the purchaser's bank 701. The service provider 705 (see FIG. 3) is not explicitly shown in FIG. 6, but is referred to in the more detailed process-flow in FIGS. 11A-11B. In a step “1” the developer prepares plans for a proposed apartment complex. Clearly, other types of property transaction could equally be used to illustrate the disclosed mbill arrangements. As part of the step “1” the developer also typically markets the proposed apartment complex in order to identify prospective purchasers. In a subsequent step “2” the developer and the purchaser negotiate a price for an apartment which the purchaser wishes to purchase. Thereafter, in a step “3” the developer and the purchaser agree to operate under the mbill arrangements.

In a subsequent step “3′” the developer presents the purchaser with the mbill draft pre-sale contract for sale of land. This type of pre-sale contract for sale of land is in a much more standardised form than the corresponding contract that is considered in the step “2′” in FIG. 1. The purchaser's solicitor firstly verifies, through the register 322 (see FIG. 5), whether the developer and the building project have been registered on the mbill system (also see a step 1003 in FIG. 11A). There is then some negotiation between the purchaser and the developer, via their respective solicitors, in regard to details in the mbill pre-sale contract for sale of land. Although there may be some minor variations to the mbill pre-sale contract for sale of land between the step “3′” and the step “10”, the variation will typically be much less than is the case for the corresponding contract described in relation to FIG. 1 because of the standardised nature of the mbill pre-sale contract for sale of land.

After the aforementioned negotiations are completed, the purchaser presents in a following step “4”, typically via the purchaser's solicitor, the mbill pre-sale contract for sale of land to the purchaser's bank in order for the purchaser's bank to determine whether the contract is satisfactory.

In a following step “5” the purchaser's bank then authenticates the mbill pre-sale contract for sale of land that has been received from the purchaser. The authentication includes consulting the register 322, to verify that the property in question is being developed by a developer who is licenced on the mbill system. The authentication also includes verifying that the particular building project is listed on the register 322. Furthermore, the authentication includes verifying that the (purported) mbill pre-sale contract for sale of land conforms to the requirements of an mbill pre-sale contract for sale of land set out in the standards. This element of the authentication comprises checking that the mbill pre-sale contract for sale of land contains the necessary clauses, and does not, for example, give disqualifying rights (rights which, inter alia, may allow unilateral voiding or termination of the contract) to any party. The bank can do this in house or can send the contract to a panel lawyer. Such panel lawyers (for mbill pre-sale contract for sale of land purposes) also need to be approved/licenced by the service provider 705.

In a subsequent step “6” the purchaser's bank assesses the worth of the purchaser, and typically, takes security from the purchaser in order to secure the amount sought to be guaranteed in the mbill system undertaking. The purchaser's bank also, in a subsequent or concurrent step “7” takes an enduring limited power of attorney from the purchaser enabling the purchaser's bank to take a mortgage on the apartment being purchased by the purchaser, and/or to otherwise deal with or dispose thereof, in the event that the purchaser defaults on his or her obligations. The various assurances and securities sought by the purchaser's bank in order to secure the amount to be guaranteed by the mbill system undertaking can vary according to the bank in question and the national jurisdiction in question.

In a following step “8” the purchaser's bank requests a number for the mbill system undertaking from the service provider 705, in order to uniquely identify the property transaction. The numbering system identifies the specific development project, being the apartment complex being constructed in the present example, and the mbill system standards specify how such numbers may be constructed and formatted. The purchaser's bank may also wish to add their own identifying number into the number for the mbill system undertaking. The purchaser's bank then issues an mbill system undertaking for the total purchase price of the apartment being purchased by the purchaser, less the rebate being offered to the purchaser (see 707 in FIG. 3). The details of the mbill system undertaking are sent to the service provider by the purchaser's bank for registration on the register. These details include the apartment being purchased, the face value of the mbill system undertaking, and the purchaser's bank identity details.

In a following step “9” the purchaser's bank also puts into place a loan facility to provide the funds required by the purchaser to complete/settle the purchase. The risk that a purchaser will be unable to settle the purchase (due to insufficient funds, the finance risk) is therefore substantially reduced or even removed. This substantial reduction, or removal, of finance risk provides an inducement to the purchaser to enter into the transaction, thereby assisting the developer's marketing effort. In a following step “10” the developer and the purchaser exchange contracts, (these being the mbill pre-sale contracts for sale of land that were negotiated in the step “3′”) thereby mutually agreeing that the purchaser will purchase the designated apartment off the plan from the developer. In a following or a concurrent step “11”, the purchaser hands the mbill system undertaking that issued from the purchaser's bank in the step “8” to the developer. In contrast to the prior art arrangement depicted in FIG. 1, there is no need for the purchaser to give a deposit or a deposit bond to the developer.

In a subsequent step “12” the developer may assign the mbill system undertaking to the developer's bank. In exchange for assignment of a number of mbill system undertakings, as exemplified by the step “12”, from the developer, the developer's bank provides, in a step “13”, the necessary construction finance to the developer subject to any other requirements being met. The mbill system undertakings that are assigned to the developer's bank by the developer in the step “12” constitute the mbill pre-sale guarantee component required by the developer's bank to provide the funds in a step “13” below. The security provided by the mbill system undertakings enables the developer's bank to use a higher LVR than would have been the case in the step “7” in FIG. 1. Thereafter, in a step “14”, the developer completes construction of the apartment building complex.

Under normal circumstances, once the construction of the apartment complex is completed, the property transaction between the developer and the purchaser will be completed in a normal fashion as depicted by the steps “15”-“17”. Accordingly, in the step “15” the purchaser draws on the loan facility set up in the step “9” from the purchaser's bank for the funds to complete/settle the transaction. Thereafter, in the step “16” the settlement process is completed between the developer and the purchaser, by which in the step “17” ownership of the completed apartment passes from the developer to the purchaser, and the developer receives the agreed purchase price from the purchaser. It is noted that the price paid by the purchaser to the developer is determined on the basis of the full valued purchase price of the apartment (as negotiated in step “2”) less the rebate paid at 707 in FIG. 3. In practice the loan funds pass directly from the purchaser's bank to the developer (or even directly to the developer's bank). The developer then returns the mbill system undertaking to the purchaser, who returns it to the purchaser's bank for cancellation.

If, on the other hand, the purchaser refuses to comply, or cannot comply, with his settlement obligations, then the developer, (or the developer's bank if the mbill system undertaking has been assigned), presents the mbill system undertaking to the purchaser's bank in the step “15′”. The purchaser's bank honours the mbill system undertaking and pays out the funds that have been guaranteed (per the step “8”) directly to the developer or to the developer's bank respectively according to whether the mbill system undertaking was not, or was assigned in the step “12”. In the following step “16′” the settlement process is completed, possession of the apartment is passed to the purchaser (step “17′”), and a mortgage on the apartment is put into place by the purchaser's bank using the enduring limited power of attorney taken by the purchaser's bank from the purchaser in the step “7”. The purchaser's bank puts the property into the purchaser's name using the enduring limited power of attorney. If the mbill system undertaking is not assigned in the step “12” then the developer, in a step “18”, repays the financing to the developer's bank, which was received in the step “13”.

In the unlikely event that the limited power of attorney (see the step “7”) fails due to the death or bankruptcy of the purchaser, a number of alternatives are available to the bank. The bank will have paid out under the mbill but due to the failure of the limited power of attorney, the bank will be unable to sign the property into the purchaser's name, and consequently will be unable to take a mortgage over the new property. Typically, in this situation, a trustee in bankruptcy or an executor will properly attend to the transaction. Failing this, the bank can take possession of the property itself or the bank can obtain a form of mortgage protection insurance.

Another contingency that can arise is that the apartment never gets delivered and therefore the contract simply fails. In this event there is no deposit to be returned to the purchaser, however the purchaser is out of pocket by the mbill fees paid to the issuing bank in addition to any other expenses incurred, such as legal expenses. In this situation, insurance will typically be available to the purchaser to reimburse their costs.

Although not shown explicitly in FIG. 6 it is evident that the purchaser's bank is able, by virtue by the enduring limited Power of Attorney received in the step “7” from the purchaser, and by virtue of the security taken from the purchaser in the step “6”, to deal with the apartment received in the step “17′” so as to recover money owed to the purchaser's bank by the purchaser.

As previously noted, if the purchaser dies or becomes bankrupt, the limited power of attorney fails, and other procedures are followed as described in relation to FIG. 6.

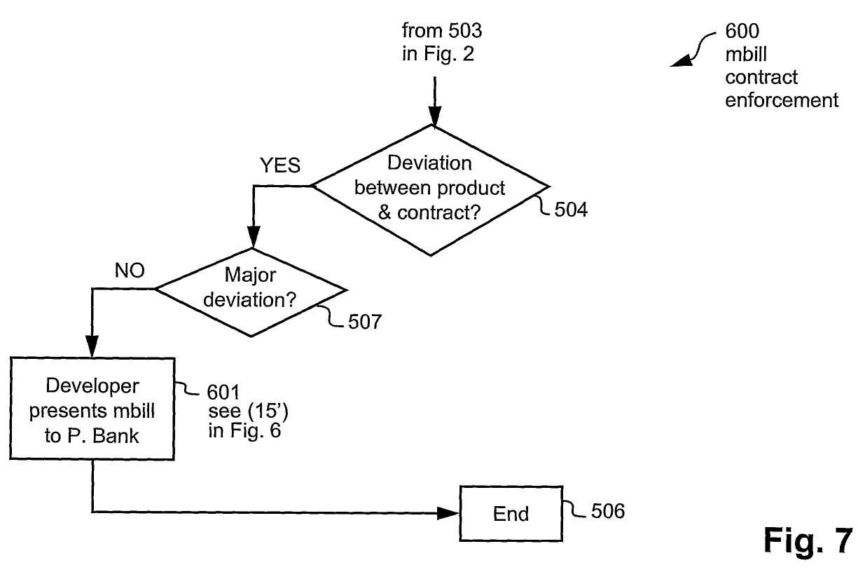

FIG. 7 shows how the disclosed mbill arrangement effects an advantageous method of completing the property transaction described in relation to FIG. 6. FIG. 7 shows a process fragment 600 which replaces the steps 509-512 in FIG. 2. The steps 504 and 507 are identical to the corresponding steps in FIG. 2. However, if the step 507 in FIG. 7 determines that a major deviation has not occurred, then the process 600 is directed by a NO arrow to a step 601 in which the developer presents the mbill system undertaking to the purchaser's bank, as depicted by the step “15′” in FIG. 6. The step 601 in FIG. 7 depicts the steps “15′”-“17′” as depicted in FIG. 6. It is noted that the presentation of the mbill system undertaking in the step 601, and the consequent enforced settlement of the transaction according to the steps “15′”-“17′” in FIG. 6, does not prevent the purchaser from using whatever legal recourse is available to rectify the minor “problem” identified in the step 507. The mbill system does however ensure that this legal process happens after settlement and cannot hold up settlement.

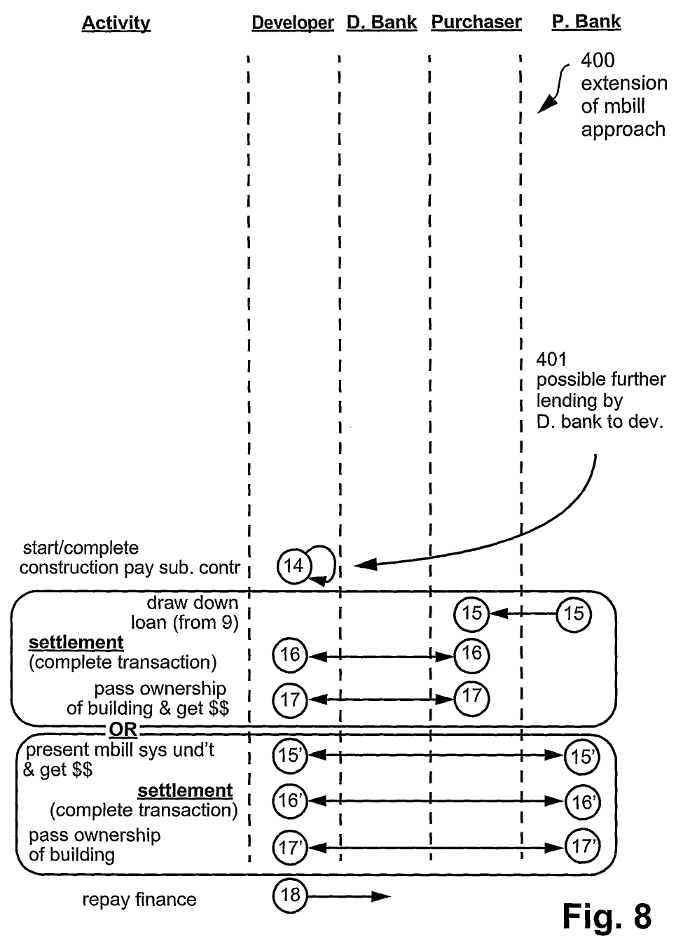

FIG. 8 shows an amended data-flow and process-flow process derived from FIG. 6 for performing the disclosed mbill arrangement. In FIG. 8 since the mbill arrangement reduces or eliminates the risk to the developer's bank when compared to current methods, the developer's bank can provide additional funds to the developer for future projects prior to completion of the current construction project. The arrow 401 depicts the situation in which once a current construction project reaches a certain stage of completion, say the stage of “lock-up”, the developer's bank is prepared to lend additional funds to the developer prior to receiving repayment of the previous funds via the step “18” in FIG. 6. The fact that the developer's bank can lend funds for future projects to the developer prior to completion/settlement of all or a significant number of property transactions on a present project enables the developer's bank to retain developer customers, since developers will be less likely to look around for new sources of funding while still owing funds to a particular developer's bank. The issues raised in regard to FIG. 6 in relation to failure of the limited power of attorney, and the typical methods for addressing these issues, also apply in regard to FIG. 8.

There are at least two ways in which the mbill arrangements can facilitate developer financing. One way results from the fact that developer's banks have more security and thus certainty for allowing funding of an existing project. Where reliance is placed on the mbill arrangements for the funding of any current project, then the financing benefit is referred to as the “Immediate Benefit”. An alternative benefit is to allow early access to equity (ie. as a means for securing financing for a subsequent project) from a current project, prior to its completion, for use in commencing a subsequent project (ie. securing the land). This is referred to as the “Prospective Benefit”.

FIG. 9 shows a process 800 by which the service provider 705 licences banks (eg., 1302 and 1305 in FIG. 4) and developers (eg., 1304 in FIG. 4) on the register 322 (see FIG. 5). Typically, any bank which holds an accredited banking licence from the appropriate government agency will be automatically approved to participate in the mbill arrangements. The assessment process as it applies to developers also relies on the banks' assessments of the developers. Thus, if a bank is prepared to find a particular developer, the service provider will ascribe a certain degree of approval to developer even in the absence of further review. The ability of the service provider to reject a particular developer is, however, one mechanism to ensure that the registration process on the register 322 is not determined solely by the banks. The developers and the banks need to be entered on the register 322, so that purchasers and their lawyers can verify the genuineness of the transaction.

The process 800 commences with a decision step 801 which determines if a licensing request has been received by the service provider 705 from a bank (eg., 1302 and/or 1305) or from a developer (eg., 1304). If this is not the case, then the process 800 is returned via a NO arrow to the step 801 in a looping fashion. If, on the other hand, a license request has been received, then the process 800 follows a YES arrow to a step 802 in which the service provider 705 assesses the quality of the entity making the aforementioned application. Thereafter, if a step 803 determines that the quality of the requestor is sufficient, then the entity requesting licensing is entered onto the register 322 in a step 805. If the register 322 is being implemented in a distributed fashion across multiple databases and networks, then the step 805 also performs a synchronisation function which ensures that all the aforementioned databases accurately contain the identical information. The process 800 then is directed back to the step 801 in a looping fashion.

Returning to the step 803, if the quality of the entity requesting licensing is not found to be adequate, then the process 800 follows a NO arrow to a step 804 which rejects the application. The process 800 is then directed back to the step 801.

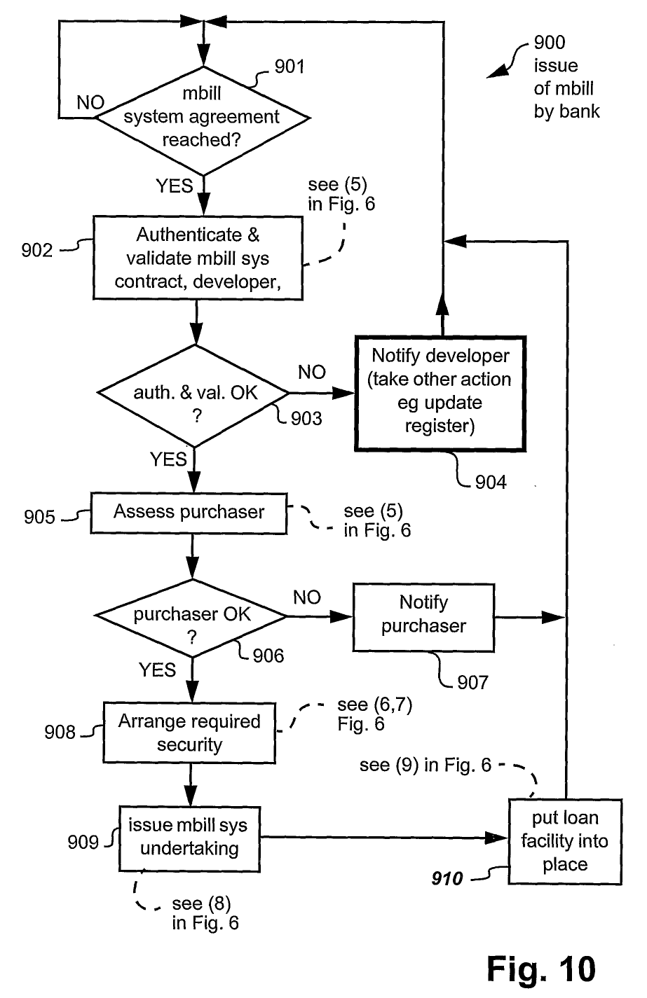

FIG. 10 depicts a process 900 according to which the purchaser's bank 702 (see FIG. 3) issues an mbill system undertaking as depicted in the steps “4”-“8” in FIG. 6. The process 900 commences with a step 901 that determines if an agreement has been reached between the purchaser and the developer to operate under the mbill arrangements. In practice this step would determine whether an application to the purchaser's bank has been received to issue an mbill system undertaking. This application would typically be accompanied by the agreed mbill pre-sale contract for sale of land so the purchaser's bank can make a decision. If such as application has not been received, then the process 900 returns via a NO arrow to the step 901 in a looping fashion.

If, on the other hand, an application for an mbill system undertaking has been received, then the process 900 follows a YES arrow to a step 902. The step 902 (see the step “5” in FIG. 6) reviews the draft mbill pre-sale contract for sale of land, and checks the developer and the project, on the register 322. A following step 903 determines if the aforementioned review and authentication step was successful. If this is the case, then the process 900 follows a YES arrow to a step 905. The step 905 (see the step “6” in FIG. 6) assesses the worth of the purchaser 701. This assessment would typically comprise an assessment of the purchaser's credit and finance rating, their assets and so on. A following step 906 determines if the aforementioned assessment process in the step 905 has produced satisfactory results. If this is the case, then the process 900 follows a YES arrow to a step 908. In the step 908, the purchaser's bank determines the total amount of security required for the issue of the mbill system undertaking and any associated loan facility. The bank thus determines how much security is provided by the new property which the purchaser wishes to purchase by obtaining a prospective valuation. The purchaser's bank also determines what LVR to apply. Thus, for example, because the property has not yet been built, the bank will not lend as much against it as an existing property. If the purchaser's bank typically lends 80% against residential property generally, the bank may decide to only lend, say, 50% against the purchase price (before rebate and as validated by prospective valuation) for the proposed purchase in question. As a result of this determination the purchaser's bank will then decide how much additional security is needed and in what form (e.g. cash deposit, other residential property, shares etc).

Thus, considering an example where the purchaser wishes to purchase a $500K property (with a 2% rebate for operating under mbill arrangements) for $490K. Assuming the purchaser's bank's prospective valuation is $500K and the bank applies an LVR of 50%, the “security value” of the new property is $250K. As the mbill system undertaking is for $490K, the bank needs another $240K in “security value”. If other existing residential property already owned by the purchaser is used to provide this additional security, (such property normally sustaining an LVR of 80%), then $300K of additional residential property is needed. The step 908 then arranges this required security (see the steps “6” and “7” in FIG. 6) from the purchaser 701.

Thereafter, a step 909 (see “8” in FIG. 6) issues the mbill system undertaking to the purchaser 701, after which a step 910 (see the step “9” in FIG. 6) puts the loan facility into place. The process 900 is then directed back to the step 901, ready to process the next purchaser.

Returning to the step 903, if the step determines that the draft mbill pre-sale contract for sale of land, or one or more of the register items, relating to the proposed transaction, fails the authentication and validation process, then the process 900 follows a NO arrows to a step 904. The step 904 may take one of several forms depending on the particular problem encountered in the step 903. Thus, for example, the developer 703 may be notified that there is an error in the project designation, and once correct information is received from the developer 703 the register 322 may be updated and the process 900 could proceed back to the step 903.

Returning to the step 906, if it is determined that the purchaser's worth is insufficient for an mbill system undertaking to be issued, then the process 900 follows a NO arrow to a step 907. In the step 907 the purchaser's bank 702 notifies the purchaser 701 of the aforementioned conclusion. The process 900 is then directed back to the step 901 ready to process the next purchaser

FIG. 11A shows a process fragment 1000′ which incorporates register operations into the process in FIG. 6. The process fragment 1000′ commences with a start step 1001 after which the developer in question is registered on the register 322. The developer 703 then applies, in a step 1002, to the service provider 705 to register the construction project (which is an apartment complex in this example). In a following step 1003, the service provider 705 registers the project in the register 322. In a following step 1004 the purchaser and the developer negotiate a price for the apartment concerned and agree to operate under the mbill arrangements. In a following step 1022 the developer provides a draft mbill pre-sale contract for sale of land to the purchaser who reviews and amends the contract, if necessary, assisted by the purchaser's and the developer's solicitors. The purchaser then forwards the amended/agreed mbill pre-sale contract for sale of land to their purchaser's bank for review. Thereafter in a step 1020 the purchaser's bank reviews the contract and the purchaser's worth, and if the contract and the assessment of the purchaser's worth are positive (per the steps 902, 903, 905 and 906 in FIG. 10) then the purchaser's bank asks the service provider for a number for the mbill system undertaking. In a following step 1005 the purchaser's bank advises the service provider with details of the transaction and with details of the purchaser's bank. In a following step 1021 the purchaser's bank issues the mbill system undertaking to the purchaser, and in a following step 1006 the service provider 705 registers the transaction.

The agreement to operate under the mbill arrangements in the step 1004 typically involves a definition of a timeframe within which the exchange of contracts (see the steps “10” and “11” in FIG. 6) must take place. If the purchaser is not able to exchange contracts in this timeframe, then the property simply goes back on the market (subject to further negotiation and the state of the market). The developer may however be more flexible with the purchaser operating under the mbill arrangements than with purchasers operating outside the mbill arrangements. Furthermore, if the developer needs mbill arrangement pre-sales (eg for the step “12” in FIG. 6), then the developer typically allows the purchaser this extra time.

Returning to FIG. 11A, if the purchaser 701 is ready to exchange within the timeframe allowed by the agreement in the step 1004, then the process fragment 1000′ is directed to the symbol “A” in regard to which a corresponding symbol is shown in FIG. 11B. If, on the other hand, the purchaser 701 is unable to meet the required timeframe for exchange in the step “10” of FIG. 6, then the process fragment 1000′ follows a NO arrow to a step 1008 in which the developer 703 puts the apartment back on the market, and the process fragment 1000′ terminates at an END step 1009. This event is recorded on the register 322.

FIG. 11B shows a process fragment 1000″ which is the continuation of the process fragment 1000′ in FIG. 11A. The symbol “A” is directed to a step 1023 in which the mbill pre-sale contract for sale of land is exchanged (see the step “10” in FIG. 6). In a following step 1010 the developer 703 assigns the issued mbill system undertaking to the developer's bank 704 as security (see the step “12” in FIG. 6) This serves as one of a number of such security items which the developer's bank 704 may require in relation to covering sales/settlement risk prior to advancing the developer 703 the funds in the step “13” in FIG. 6. Thereafter, in a step 1011, the developers bank notifies the service provider 705 of the assignment, after which the service provider 705 registers the change of ownership of the mbill system undertaking in the register 322 in a step 1012.

If, at this point, the developer fails to deliver the apartment as specified, then the process 1000″ fails (see a step 1201 in FIG. 12). This event is recorded on the register 322. In this event, the purchaser's costs can typically be reimbursed via a suitable insurance arrangement.

A following step 1013 represents the decision point at which settlement takes place, either in the “normal” manner (as depicted by the steps “15”-“17” in FIG. 6) or, if the purchaser does not honour their obligations, by the mbill system undertaking being presented by the developer 703 to the purchaser's bank 702 (as depicted by the steps “15′”-“17′” in FIG. 6.

If normal settlement takes place, then the process fragment 1000″ follows a NORMAL arrow to a step 1014. In the step 1014, the settlement process is completed meaning that title is transferred from the developer 703 to the purchaser 701, and the settlement dollars are transferred from the purchaser's bank 702 to the developer (or possibly to the developer's bank in repayment of the development finance). The mbill system undertaking is returned to purchaser at settlement, and the purchaser immediately passes it on to the purchaser's bank (as part of the settlement process) for cancellation (note that this return of the mbill system undertaking does not constitute “presentation” of the mbill system undertaking but rather merely return of the document for cancellation by the purchaser's bank 702). Thereafter, the process fragment 1000″ is directed to an END step 1018. This event is recorded on the register 322. It is noted that the service provider received the fee 710 in FIG. 3 in a progressive manner, synchronised with the payment 706 from the purchaser to the purchaser's bank.

Returning to the step 1013, if normal settlement does not occur, then the process fragment 1000″ is directed by an arrow entitled mbill PRES to a step 1015. The step 1015 is described in more detail in regard to FIG. 12, however in essence the step 1015 determines whether the construction project meets the required mbill system undertaking requirements. If this is the case, then the process fragment 1000″ follows a YES arrow to a step 1016. In the step 1016, the settlement process is completed between the developer 703 and the purchaser's bank 702, title of the apartment in question is transferred from the developer 703 to the purchaser (by the purchasers bank operating under the enduring limited power of attorney taken in the step “7” in FIG. 6) and a mortgage is put in place over the new property (also by the purchaser's bank operating under the enduring limited power of attorney). With reference to the steps 1016 and/or 1017, the issues arising from a failure of the limited power of attorney, and the typical procedures for dealing with this contingency as described in relation to FIG. 6, apply here.

The settlement dollars specified in the mbill system undertaking are transferred from the purchaser's bank 702 to the developer 703. This event is recorded on the register 322. The service provider 705 having received the fee 710. Thereafter, in a step 1017, the purchaser's bank 702 deals with the apartment and with the security taken by the purchaser's bank 702 from the purchaser 701 in the step “6” in FIG. 6, in order to cover the obligations of the purchaser to the purchaser's bank. Thus, for example, if the property is in the purchaser's name, the purchaser's bank holds discussions with the purchaser about repayment, or “forecloses” on the mortgage that the bank has also put in place with the enduring limited power of attorney. Thereafter, the process fragment 1000″ is directed to the step 1018, and the process fragment 1000″ terminates.

Returning to the step 1015, if the mbill system undertaking does not meet the requisite mbill arrangement criteria, then the process fragment 1000″ follows a NO arrow to a step 1019 which determines if the developer still has time to meet the criteria in the mbill system undertaking within the time frame allowed by the mbill pre-sale contract for sale of land. If this is the case, then the process fragment 1000″ is directed by a YES arrow back to the step 1015 until the contract “drop dead date” which is the last date possible under the contract, in which case the process fragment 1000″ is directed by a NO arrow from the step 1019 to a step 1201 in FIG. 12. The step 1201 means that the entire deal between the purchaser and the developer is cancelled, or in other words, the contract fails or lapses. This event is recorded on the register 322.

FIG. 12 shows the process 1015 of FIG. 11B in more detail. The process 1015 determines if the construction project meets all the criteria of the mbill system undertaking, this being necessary to determine whether the settlement process can be performed using the mbill arrangements. The process 1015 commences with a step 1200 which determines whether the building project has been completed. If this is not the case, then the process 1015 follows a NO arrow to a step 1201 which declares that the criteria of the mbill system undertaking have not been met. In this event, the mbill system undertaking will not be honoured by the purchaser's bank 702, and the settlement process 1016 cannot be completed using the mbill system undertaking. If, on the other hand, the step 1200 determines that the project has been completed, then the process 1015 follows a YES arrow to a step 1202 which determines whether a title document has been created in the Land Titles Office for the apartment that has been completed. This is generally an essential step in creating title to the apartment which can then be passed to the purchaser 701 or the purchaser's bank 702. If the step 1202 determines that title has created, then the process 1015 follows a YES arrow to a step 1203 which determines if a Transfer of Title Document has been executed and is attached to the mbill system undertaking that has been presented by the developer 703 to the purchaser's bank 702 in the step “15′” in FIG. 6. The Transfer of Title document is a standard Land Titles Office document that must be presented to the Land Titles Office for them to register the change of owner. If this is the case, then the process 1015 follows a YES arrow to a step 1204 which determines if relevant time limits, set out in the mbill system undertaking have been met. If this is the case then the process 1015 follows a YES arrow to the step 1016 in FIG. 11B.

Returning to the step 1202, if a title document has not been created in the Land Titles Office, then the process 1015 follows a NO arrow to the step 1201. Similarly, if having regard to the step 1203, a transfer document has not been executed, then the process 1015 follows a NO arrow to the step 1201. Similarly, if having regard to the step 1204, the time limits of the mbill system undertaking have been exceeded, then the process 1015 follows a NO arrow to the step 1201. This event is recorded on the register 322.

Clearly the process 1015 in FIG. 12 is specific to the formal requirements in a specific jurisdiction. However, the mbill arrangements can be used with other formal requirements provided that the mbill arrangements are suitably adapted.

The aforementioned preferred method(s) comprise a particular control flow. There are many other variants of the preferred method(s) which use different control flows without departing the spirit or scope of the invention. Furthermore one or more of the steps of the preferred method(s) may be performed in parallel rather than sequentially.

### INDUSTRIAL APPLICABILITY

It is apparent from the above that the arrangements described are applicable to the building and construction and the finance industries.

The foregoing describes only some embodiments of the present invention, and modifications and/or changes can be made thereto without departing from the scope and spirit of the invention, the embodiments being illustrative and not restrictive.

Accordingly, the described arrangements can also be used in a similar manner for purchasing major capital items. For example, an imported car could be secured by a purchaser using an mbill system undertaking, with the trigger being registration of the vehicle for use on the local roads.

1. A system for selling a property off the plan, by a developer to a purchaser, prior to completion of the property, the system comprising:
a contract according to which the developer agrees to complete the property and sell the property to the purchaser for a first amount;
a time-limited, conditional, stand-by undertaking that a finance provider of the purchaser will, subject to completion of the property and receipt of a document needed to obtain title to the property, pay a second amount that is related to the first amount to a finance provider of the developer;
an electronically accessible register;
a machine comprising a memory for storing a program and a processor for executing the program, said program comprising:
code for accessing the electronically accessible register to ensure that a right over the undertaking has not been accepted by another party;
said right over the undertaking, which, if it has not been accepted by a said other party, is provided to a finance provider of the developer; said program further comprising:
code for registering acceptance by the finance provider of the developer of the provided right over the undertaking on the register; and
a payment, if the purchaser does not pay the second amount to the developer upon completion of the property and receipt a document needed to obtain title over the property, by the finance provider of the purchaser of the second amount to the finance provider of the developer provided that (i) the finance provider of the developer cashes in the undertaking; and (ii) the property has been completed and the document needed to obtain title to the property is provided to the finance provider of the purchaser.

2. A register, being electronically accessible, in a system for selling a property off the plan, the selling being by a developer to a purchaser, prior to completion of the property, the system comprising (a) a contract according to which the developer agrees to complete the property and sell the property to the purchaser for a first amount; (b) a time-limited, conditional, stand-by undertaking that a finance provider of the purchaser will, subject to completion of the property and receipt of a document needed to obtain title to the property, pay a second amount that is related to the first amount to a finance provider of the developer; and (c) a machine comprising a memory for storing a program and a processor for executing the program; said register comprising:
means for providing, in accordance with coded instructions in said program, access to stored data, said access enabling confirmation in accordance with the data that a right over the undertaking has not been accepted by another party; and
means for enabling, in accordance with coded instructions in said program, registration of acceptance by the finance provider of the developer of a right over the undertaking on the register if said right over the undertaking has not been accepted by another party.

3. A method of selling a property off the plan, by a developer to a purchaser, prior to completion of the property, the method comprising the steps of:
effecting a contract according to which the developer agrees to complete the property and sell the property to the purchaser for a first amount;
issuing a time-limited, conditional, stand-by undertaking that a finance provider of the purchaser will, subject to completion of the property and receipt of a document needed to obtain title to the property, pay a second amount that is related to the first amount to a finance provider of the developer;
accessing an electronically accessible register to ensure that a right over the undertaking has not been accepted by another party;
if a said right over the undertaking has not been accepted by a said other party, providing a right over the undertaking to a finance provider of the developer and registering acceptance by the finance provider of the developer of the provided right over the undertaking on the register; and
if the purchaser does not pay the second amount to the developer upon completion of the property and receipt a document needed to obtain title over the property, the finance provider of the purchaser paying the second amount to the finance provider of the developer provided that (i) the finance provider of the developer cashes in the undertaking; and (ii) the property has been completed and the document needed to obtain title to the property is provided to the finance provider of the purchaser.

4. A method of selling a property off the plan, by a developer to a purchaser, prior to completion of the property, the method comprising the steps of:
effecting a contract according to which the developer agrees to complete the property and sell the property to the purchaser for a first amount;
issuing a time-limited, conditional, stand-by undertaking that a finance provider of the purchaser will, subject to completion of the property and receipt of a document needed to obtain title to the property, pay a second amount that is related to the first amount to a finance provider of the developer;
providing a right over the undertaking to the finance provider of the developer; and
if the purchaser does not pay the second amount to the finance provider of the developer upon completion of the property, the finance provider of the purchaser paying the second amount to the finance provider of the developer provided that (i) the finance provider of the developer cashes in the undertaking; and (ii) the property has been completed and the document needed to obtain title to the property is provided to the finance provider of the purchaser.

5. A method according to claim 4, wherein an amount payable to the finance provider of the developer is instead payable to the developer.

6. A method according to claim 5, wherein an amount payable to one of the finance provider of the developer and the developer is paid via a third party intermediary.

7. A method according to claim 4, wherein the contract is a standardised pre-sale contract for sale of property.

8. A method according to claim 4, wherein the issuing of the undertaking further comprises a step of taking security, by the finance provider of the purchaser, over at least one of the property being sold and other property in which the purchaser has an interest.

9. A method according to claim 8, wherein the issuing of the undertaking further comprises a step of taking a power of attorney in favour of the finance provider of the purchaser from the purchaser enabling the finance provider of the purchaser to deal with the property if the purchaser does not pay the second amount to one of the developer and the finance provider of the developer upon completion of the property.

10. A method according to claim 4 comprising a further step of providing a loan facility, contingent upon the issuing of the undertaking, to provide the funds required by the purchaser to pay the second amount to one of the developer and the finance provider of the developer.

11. A method according to claim 4, comprising the further steps of:
registering the issuing of the undertaking on an electronically accessible register;
accessing the register, prior to acceptance by the finance provider of the developer of the provided right over the undertaking, to ensure that a said right over the undertaking has not previously been accepted by another party; and
if a said right over the undertaking has not previously been accepted by another party, providing the right over the undertaking to the finance provider of the developer and registering acceptance of the provided right on the register.

12. A method according to claim 4, wherein at least one of:
the issuing step comprises paying said second amount to the finance provider of developer via another party; and
the providing step comprises providing a right over the undertaking to the finance provider of the developer via another party; and
if the purchaser does not pay the second amount to the finance provider of the developer upon completion of the property and receipt of the document needed to obtain title to the property, the finance provider of the purchaser paying the second amount to the finance provider of the developer via another party.

13. A method of selling a property off the plan, by a developer to a purchaser, prior to completion of the property, wherein a time-limited, conditional, stand-by undertaking is issued by a finance provider of the purchaser that said finance provider of the purchaser will, subject to completion of the property and receipt of a document needed to obtain title to the property, pay a second amount to a finance provider of the developer; the method comprising the steps of:
effecting a contract according to which the developer agrees to complete the property and sell the property to the purchaser for a first amount that is related to the second amount;
providing a right over the undertaking to the finance provider of the developer; and
if the purchaser does not pay the second amount to the finance provider of the developer upon completion of the property, receiving, from the finance provider of the purchaser, said second amount provided that (i) the finance provider of the developer cashes in the undertaking; and (ii) the property has been completed and the document needed to obtain title to the property is provided to the finance provider of the purchaser.

14. A method according to claim 13, wherein an amount payable to the finance provider of the developer is instead payable to the developer.

15. A method according to claim 14, wherein an amount payable to one of the finance provider of the developer and the developer is paid via a third party intermediary.

16. A method according to claim 13, wherein the issuing of the undertaking is registered on an electronically accessible register, said method comprising the further steps of:
accessing the register, prior to acceptance by the finance provider of the developer of the provided right over the undertaking, to ensure that a said right over the undertaking has not previously been accepted by another party; and
if a said right over the undertaking has not previously been accepted by another party, providing the right over the undertaking to the finance provider of the developer and registering acceptance of the provided right on the register.

17. A method of purchasing a property off the plan, by a purchaser from a developer, prior to completion of the property, the method comprising the steps of:
effecting a contract according to which the developer agrees to complete the property and sell the property to the purchaser for a first amount;
arranging for issue of a time-limited, conditional, stand-by undertaking that a finance provider of the purchaser will, subject to completion of the property and receipt of a document needed to obtain title to the property, pay a second amount that is related to the first amount to a finance provider of the developer if the undertaking is cashed in: and
ensuring, consequent to the arranging of the undertaking, availability of funds required by the purchaser to complete the purchase from the finance provider of the purchaser.

18. A method of providing finance by a finance provider of a developer to the developer, in relation to sale of a plurality of properties off the plan, by the developer to a corresponding plurality of purchasers, prior to completion of the properties, the method comprising the steps of:
receiving rights over a corresponding plurality of time-limited, conditional, stand-by undertakings issued by respective finance providers of the purchasers that each said finance provider of a said purchaser will, subject to completion of the corresponding property and receipt of a document needed to obtain title said property, pay a corresponding second amount to the developer;
increasing the Loan-to-Value ratio associated with the provision of the finance depending upon the receiving of the rights over the undertakings; and
providing said finance according to the increased Loan-to-Value ratio.

19. A method according to claim 18, wherein the step of providing said finance comprises providing finance to the developer relating to properties other than said plurality of properties.

20. A method according to claim 18, wherein the issuing of the undertakings are registered on an electronically accessible register, said method comprising the further steps of:
accessing the register, prior to providing of said finance to the developer, to ensure that none of said rights over the undertakings have previously been accepted by another party; and
if none of said rights have previously been accepted by another party, registering acceptance of the received rights on the register, and providing the finance to the developer.

21. A method of providing finance by a finance provider of a purchaser to the purchaser in relation to purchase of a property off the plan, by the purchaser from a developer, prior to completion of the property, the method comprising the steps of:
effecting a contract according to which the developer agrees to complete the property and sell the property to the purchaser for a first amount; and
arranging for issue of a time-limited, conditional, stand-by undertaking that the finance provider of the purchaser will, subject to completion of the property and receipt of a document needed to obtain title to the property, pay a second amount that is related to the first amount to the finance provider of the developer if the undertaking is cashed in.

22. A method according to claim 21, wherein the issuing of the undertaking further comprises a step of ensuring, consequent to the arranging of the undertaking, availability of funds from the bank of the purchaser that are required by the purchaser to complete the purchase.

23. A method according to claim 22, wherein the issuing of the undertakings are registered on an electronically accessible register.

24. A system for selling a property off the plan, by a developer to a purchaser, prior to completion of the property, the system comprising:
a contract according to which the developer agrees to complete the property and sell the property to the purchaser for a first amount;
a time-limited, conditional, stand-by undertaking that a finance provider of the purchaser will, subject to completion of the property and receipt of a document needed to obtain title to the property, pay a second amount that is related to the first amount to a finance provider of the developer;
an electronically accessible register that is accessible to ensure that a right over the undertaking has not been accepted by another party;
a right over the undertaking, which if not accepted by a said other party, is provided to a finance provider of the developer;
registration of acceptance by the finance provider of the developer of the provided right over the undertaking on the register; and
the second amount, being payable to the finance provider of the developer by the finance provider of the purchaser if the purchaser does not pay the second amount to the developer upon completion of the property and receipt a document needed to obtain title over the property, said second amount being payable provided that:
(i) the finance provider of the developer cashes in the undertaking; and
(ii) (ii) the property has been completed and the document needed to obtain title to the property is provided to the finance provider of the purchaser.

25. A system for selling a property off the plan, by a developer to a purchaser, prior to completion of the property, the system comprising:
a contract according to which the developer agrees to complete the property and sell the property to the purchaser for a first amount;
a time-limited, conditional, stand-by undertaking that a finance provider of the purchaser will, subject to completion of the property and receipt of a document needed to obtain title to the property, pay a second amount that is related to the first amount to a finance provider of the developer;
an electronically accessible register storing information establishing whether a right over the undertaking has been accepted by a third party:
said right over the undertaking that is accepted by the finance provider of the developer provided that the information in the register establishes that the undertaking has not been accepted by a third party; and
said second amount, payable by the finance provider of the purchaser to the finance provider of the developer if the purchaser does not pay the second amount to the finance provider of the developer upon completion of the property, said second amount being paid by the finance provider of the purchaser to the finance provider of the developer provided that:
(i) the finance provider of the developer cashes in the undertaking; and
(ii)(ii) the property has been completed and the document needed to obtain title to the property is provided to the finance provider of the purchaser.

26. A system for selling a property off the plan, by a developer to a purchaser, prior to completion of the property, wherein a time-limited, conditional, stand-by undertaking is issued by a finance provider of the purchaser that said finance provider of the purchaser will, subject to completion of the property and receipt of a document needed to obtain title to the property, pay a second amount to a finance provider of the developer; the system comprising:
a contract according to which the developer agrees to complete the property and sell the property to the purchaser for a first amount that is related to the second amount;
an electronically accessible register storing information establishing whether a right over the undertaking has been accepted by a third party:
said right over the undertaking that can be accepted by the finance provider of the developer provided that a right over the undertaking has not been accepted by a third party; and
said second amount, receivable by the finance provider of the developer from the finance provider of the purchaser if the purchaser does not pay the second amount to the finance provider of the developer upon completion of the property, said second amount being receivable provided that:
(i) the finance provider of the developer cashes in the undertaking; and
(ii)(ii) the property has been completed and the document needed to obtain title to the property is provided to the finance provider of the purchaser.

27. A system for purchasing a property off the plan, by a purchaser from a developer, prior to completion of the property, the system comprising:
a contract according to which the developer agrees to complete the property and sell the property to the purchaser for a first amount;
a time-limited, conditional, stand-by undertaking that a finance provider of the purchaser will, subject to completion of the property and receipt of a document needed to obtain title to the property, pay a second amount that is related to the first amount to a finance provider of the developer if the undertaking is cashed in: and guaranteed funds, consequent to the arranging of the undertaking, said funds being required by the purchaser to complete the purchase, said funds being guaranteed by the finance provider of the purchaser.

28. A system for providing finance by a finance provider of a developer to the developer, in relation to sale of a plurality of properties off the plan, by the developer to a corresponding plurality of purchasers, prior to completion of the properties, the system comprising:
an electronically accessible register storing information establishing whether rights over at least one of a corresponding plurality of time-limited, conditional, stand-by undertakings issued by respective finance providers of the purchasers has been accepted by a third party:
said rights over the corresponding plurality of time-limited, conditional, stand-by undertakings issued by respective finance providers of the purchasers that each said finance provider of a said purchaser will, subject to completion of the corresponding property and receipt of a document needed to obtain title said property, pay a corresponding second amount to the developer;
a Loan-to-Value ratio associated with the provision of the finance, said Loan-to-Value ratio being increased depending upon the receiving of the rights over the undertakings provided that said at least one of a corresponding plurality of time-limited, conditional, stand-by undertakings issued by respective finance providers of the purchasers has not accepted by said third party; and
said finance, being provided according to the increased Loan-to-Value ratio.

29. A system for providing finance by a finance provider of a purchaser to the purchaser in relation to purchase of a property off the plan, by the purchaser from a developer, prior to completion of the property, the system comprising:
a contract according to which the developer agrees to complete the property and sell the property to the purchaser for a first amount; and
a time-limited, conditional, stand-by undertaking that the finance provider of the purchaser will, subject to completion of the property and receipt of a document needed to obtain title to the property, pay a second amount that is related to the first amount to the finance provider of the developer if the undertaking is cashed in.

30. A method of selling a property off the plan, by a developer to a purchaser, prior to completion of the property, wherein a time-limited, conditional, stand-by undertaking is issued by a finance provider of the purchaser that said finance provider of the purchaser will, subject to completion of the property and receipt of a document needed to obtain title to the property, pay a second amount to the developer; the method comprising the steps of:
effecting a contract according to which the developer agrees to complete the property and sell the property to the purchaser for a first amount that is related to the second amount; and
if the purchaser does not pay the second amount to the developer upon completion of the property, receiving, from the finance provider of the purchaser, said second amount provided that (i) the developer cashes in the undertaking; and
(ii) the property has been completed and the document needed to obtain title to the property is provided to the finance provider of the purchaser.

31. A method according to claim 30, wherein an amount payable to the developer is paid via a third party intermediary.

32. A computer-based method of selling a property off the plan, by a developer to a purchaser, prior to completion of the property, the method being effected over a network, the method comprising the steps of:
effecting, over the network, a contract according to which the developer agrees to complete the property and sell the property to the purchaser for a first amount;
issuing, over the network, a time-limited, conditional, stand-by undertaking that a finance provider of the purchaser will, subject to completion of the property and receipt of a document needed to obtain title to the property, pay a second amount that is related to the first amount to a finance provider of the developer;
accessing, over the network, an electronically accessible register to ensure that a right over the undertaking has not been accepted by another party;
if a said right over the undertaking has not been accepted by a said other party, providing, over the network, a right over the undertaking to a finance provider of the developer and registering acceptance by the finance provider of the developer of the provided right over the undertaking on the register; and
if the purchaser does not pay the second amount to the developer upon completion of the property and receipt a document needed to obtain title over the property, the finance provider of the purchaser paying, over the network, the second amount to the finance provider of the developer provided that (i) the finance provider of the developer cashes in the undertaking; and (ii) the property has been completed and the document needed to obtain title to the property is provided to the finance provider of the purchaser.

33. A computer-based system for selling a property off the plan, by a developer to a purchaser, prior to completion of the property, the system comprising:
a network;
a first machine incorporating a processor and a program, said program comprising code for effecting, over the network, a contract according to which the developer agrees to complete the property and sell the property to the purchaser for a first amount;
a second machine incorporating a processor and a program, said program comprising code for issuing, over the network, a time-limited, conditional, stand-by undertaking that a finance provider of the purchaser will, subject to completion of the property and receipt of a document needed to obtain title to the property, pay a second amount that is related to the first amount to a finance provider of the developer;
a third machine incorporating a processor and a program, said program comprising code for accessing, over the network, an electronically accessible register to ensure that a right over the undertaking has not been accepted by another party;
a fourth machine incorporating a processor and a program, said program comprising code which, if a said right over the undertaking has not been accepted by a said other party, is adapted for providing, over the network, a right over the undertaking to a finance provider of the developer and registering acceptance by the finance provider of the developer of the provided right over the undertaking on the register; and
a fifth machine incorporating a processor and a program, said program comprising code which, if the purchaser does not pay the second amount to the developer upon completion of the property and receipt a document needed to obtain title over the property, is adapted for paying, by the finance provider of the purchaser paying, over the network, the second amount to the finance provider of the developer provided that (i) the finance provider of the developer cashes in the undertaking; and (ii) the property has been completed and the document needed to obtain title to the property is provided to the finance provider of the purchaser.

34. A system according to claim 33, wherein at least one of the first machine, the second machine, the third machine, the fourth machine and the fifth machine are incorporated into a common machine.
